(19) United States
(12) Patent Application Publication
(10) Pub. No.: US 2008/0178507 A1
(43) Pub. Date: Jul. 31, 2008

(54) CLEAR PLASTIC TWO-SIDED POCKET CHARTS

(76) Inventor: Deandra Dean-McLeod, Lithia, FL (US)

Correspondence Address: STEVEN W. WEBB, 655 2ND STREET, ENCINITAS, CA, 92024, US

(21) Appl. No.: 11/669,702

(22) Filed: Jan. 31, 2007

(51) Int. Cl. G09F 3/18

(52) U.S. Cl. 40/661

(57) ABSTRACT

An improved presentation support system comprised of a multi-pocket display chart is presented. The chart has the additional features of a slot pocket that runs the length and width of the chart that accommodates a background poster, over which symbol and word cards can be placed in the pockets covering the front of the chart. The cards can illustrate the underlying poster.

The chart can be hung in landscape or portrait orientations and an alternate embodiment includes a two-sided feature, where the first side is in landscape orientation and the other side is in portrait orientation.

### FIELD OF THE INVENTION

This invention relates to display and presentation charts, plastic display devices, and flip charts.

### BACKGROUND OF THE INVENTION

Business and educational instructors use physical media to make presentations and to illustrate concepts, including arrangements of ideas on flip charts or presentation posters. The types of presentation media include physical media such as plastic sheets where sticky notes or writing can be placed and easels for paper flip charts.

The present invention is a new form of plastic sheet presentation poster with a unique pocket design to hold preprinted cards, symbols, and other items. The present invention's pocket charts can accommodate large and small activity charts and manipulatives, such as cards with individual words on them, arrow symbols, and the like.

The prior art includes media such as U.S. Pat. No. 5,485,694 to Goad, teaching a poster support capable of being hung on the back of a door, and U.S. Pat. No. 3,187,903 to Oltz, teaching a typical plastic pocket system that could hold and contain miscellaneous items. More specific versions of the Oltz design can be found in U.S. Pat. No. 5,682,695 to Hoffman, showing a combination presentation organizer, and U.S. Pat. No. 5,533,902 to Miller showing an educational presentation display system.

The present invention can be distinguished by the addition of a back panel holder and a more modular pocket design.

### SUMMARY OF THE INVENTION

The front and back panels of the present invention are seamed together on three sides, forming an inside pocket for inserting poster sheets. The inserted posters serve as a background for items to be placed in the front or back card pockets. The pocket chart of the present invention has snaps at the top so that inserted charts are firmly supported. The pocket chart can be made with a portrait or landscape orientation to accommodate background posters of various shapes. The chart can also be manufactured with a set of pockets on one side in portrait orientation and a set of pockets on the other side in landscape orientation with the background poster slot in the middle.

A typical use for the present invention would involve putting a background in the panel holder, such as a map, and then using the front pockets to place symbols or place names in front of the poster, illustrating it.

Users can insert plain paper or purchase insert ‘kits’ to vary their displays. Because the entire chart is clear, this pocket chart product is more versatile than traditional charts, since it allows the user to insert both commercial and noncommercial materials on the outside and interior pockets. Sets of interactive posters and cards will be published to use with the pocket charts. However, these pocket charts can also be used independently.

### OBJECTIVES OF THE PRESENT INVENTION

The objective of the present invention is to provide a methodology for illustrating educational or business presentations by means of controlling the placement of descriptive words or symbols on top of a background image.

A further objective of this invention is to make the methodology easy and cost-efficient to use.

A further objective of the present invention is to allow the methodology to be implemented with lightweight materials, suitable for the use of children.

A further objective of the present invention is to permit all types of background posters to be clearly seen.

It is an objective of this invention to to provide a presentation system that has portrait-oriented storage pockets on one side and landscape-oriented pockets on the other.

### BRIEF DESCRIPTION OF THE DRAWINGS

FIG. 1. Perspective view of the invention

FIG. 2. Front view of the landscape version of the invention

FIG. 3. Front view of the portrait version of the invention

FIG. 4. Cross section of landscape version of the invention

FIG. 5. Cross section of portrait version of the invention

### DETAILED SPECIFICATION

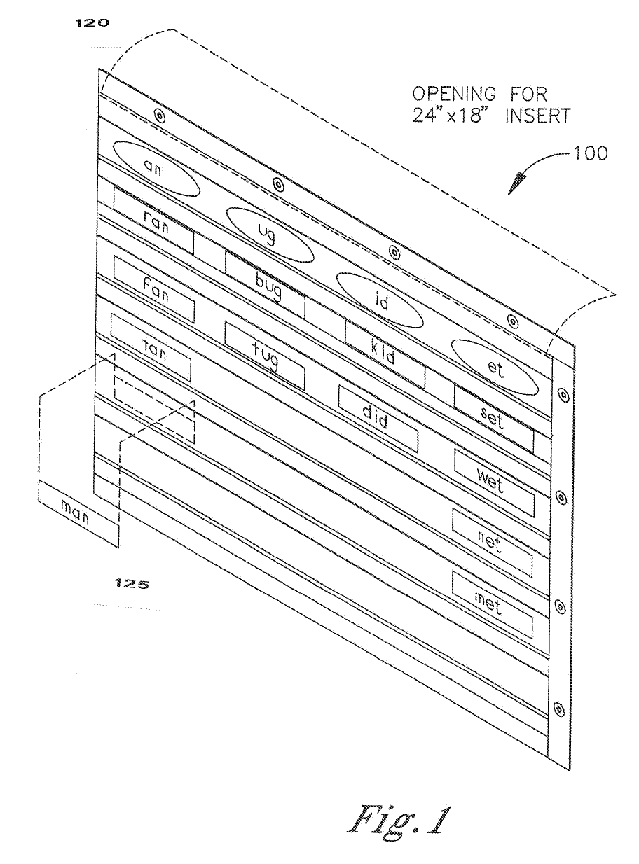

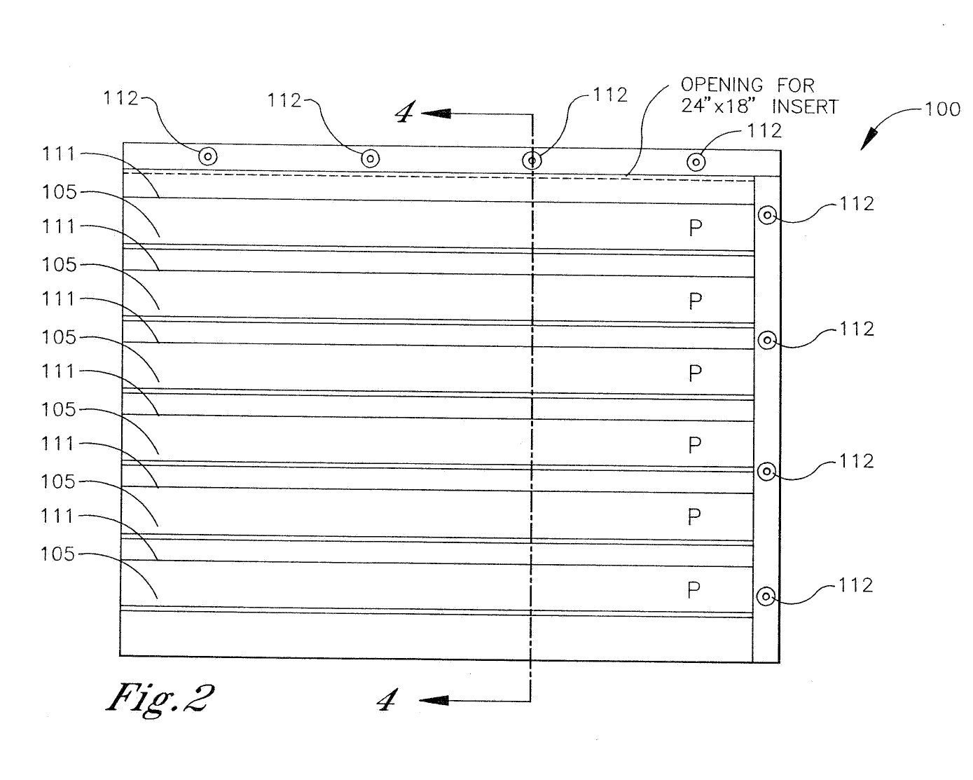

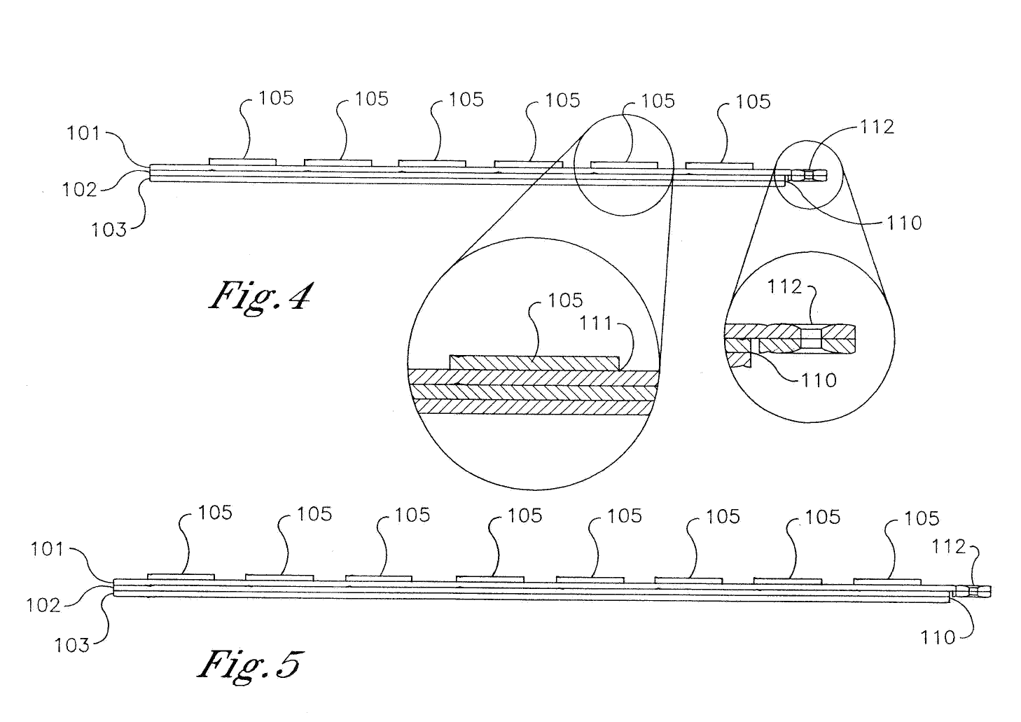

As shown in FIG. 1, FIG. 4, and FIG. 5, the present invention 100 is comprised of several layers of clear or transparent plastic 101,102,103 with a plurality of pockets 105 on one side of the invention 100. There is a poster holder slot 110 between two of the layers of plastic that is closed on three sides. The pockets 105 are have an open end 111 and are closed on the other three sides. There are a plurality of attachment holes 112 on two sides of the invention 100 suitable for hanging over hooks and the like to suspend the invention 100 in front of a class.

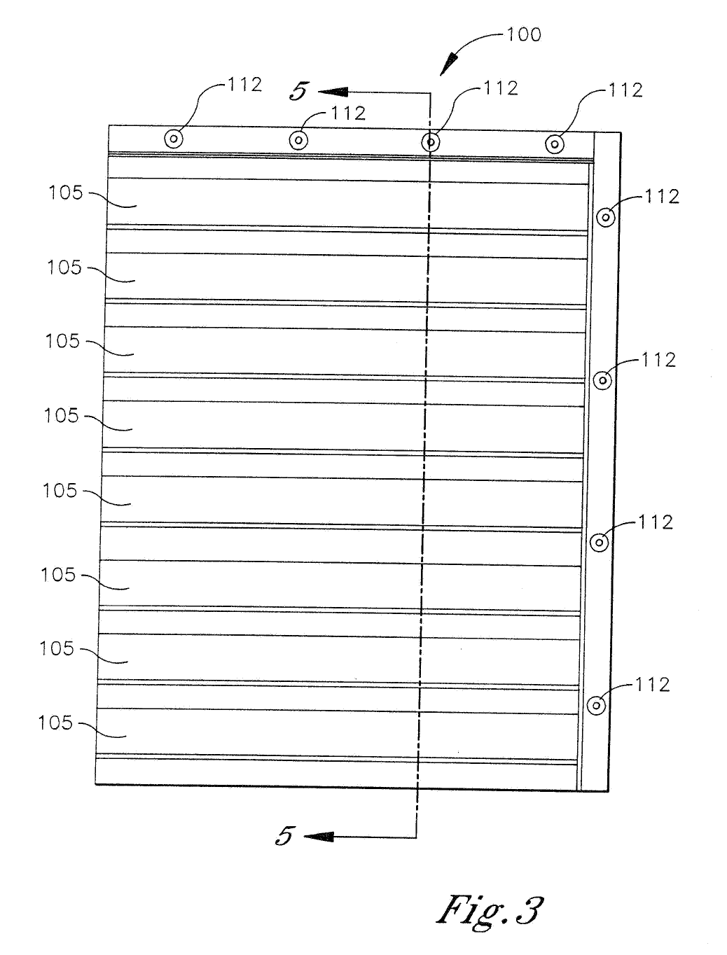

The orientation of the pockets 105 is such that the invention can be hung vertically as in FIG. 3, the landscape orientation, or horizontally as in FIG. 1, the portrait orientation. An alternate embodiment of the present invention is a configuration where one side of the invention 100 possesses portrait-oriented pockets 105 as in FIG. 1 and the other side of the invention 100 possesses a separate landscape-oriented plurality of pockets 105 as in FIG. 3. The invention could be used in either orientation by simply flipping the invention over and hanging it from a different set of attachment holes 112.

The invention 100 is used by the steps of deciding in which orientation to hang the invention 110 on a wall or other support surface, selecting a poster background 120 to be inserted into the poster holder slot 110, inserting the poster background into the poster holder slot 110, placing the invention 110 on the supporting surface by means of hooking the attachment holes 112 over the support means available, such as hooks or nails, and then inserting symbol or word cards 125 into the pockets 105 on the front of the invention such that they are supported by the pockets. The symbol or word cards 125 can be moved around easily, removed, or supplemented with other symbol or word cards 125 as needed.

While the foregoing describes a preferred mode and an alternate embodiment, variation on this design and equivalent methods may be resorted to in the scope and spirit of the claimed invention.

What is claimed is

1. (canceled)

2. (canceled)

3. A pocket chart comprised of a plurality of transparent plastic layers, the pocket chart in a rectangular shape, the pocket chart possessing a front layer and a back layer, a poster holder slot, a top, a bottom, and two sides, the front layer possessing a plurality of transparent plastic pockets, each transparent plastic pocket in the shape of a rectangle, each transparent plastic pocket fixedly attached to the pocket chart, each transparent plastic pocket closed on three sides, the open side of each transparent plastic pocket pointing towards the top of the pocket chart in a “landscape” orientation,
the pocket chart back layer possessing a plurality of transparent plastic pockets, each transparent plastic pocket in the shape of a rectangle, each transparent plastic pocket fixedly attached to the pocket chart, each transparent plastic pocket closed on three sides, the open side of each transparent plastic pocket pointing towards one of the two sides of the pocket chart in a “portrait” orientation,
the poster holder slot being a space between the plastic layers of the pocket chart that allows a poster the shape and size of the pocket chart to be inserted between the front and back layers such that the contents of the poster are seen through the transparent plastic layers,
the pocket chart possessing a plurality of attachment holes located at the top of the pocket chart and also possessing a plurality of attachment holes located at one of the two sides of the pocket chart, the attachment holes passing through all of the transparent plastic layers.

4. A method of using the pocket chart of claim 3 comprising the steps of
identifying what materials are to be held in the transparent plastic pockets of the pocket chart,
identifying the pocket chart orientation that best suits the proposed use of the pocket chart, selected from portrait or landscape,
identifying the poster to be inserted into the poster holder slot,
inserting the poster in the poster holder slot,
hanging or attaching the pocket chart in the desired orientation such that the pockets to be displayed are open-side-up,
inserting the materials to be displayed in the pockets on the pocket chart as desired.
